(19) United States
(12) Patent Application Publication
(10) Pub. No.: US 2020/0085230 A1
(43) Pub. Date: Mar. 19, 2020

(54) BEVERAGE DISTRIBUTION DISPOSITION, SYSTEM WITH SAID DISPOSITION AND PROCESS OF OPERATION OF SAID SYSTEM

(71) Applicant: NOVADELTA - COMÉRCIO E INDÚSTRIA DE CAFÉS S.A., Lisboa (PT)

(72) Inventors: Rui Miguel NABEIRO, Campo Maior (PT); Jesús MEDINA MUNDT, Lisboa (PT)

(73) Assignee: NOVADELTA - COMÉRCIO E INDÚSTRIA DE CAFÉS S.A., Lisboa (PT)

(21) Appl. No.: 16/494,606

(22) PCT Filed: Mar. 16, 2018
(86) PCT No.: PCT/PT2018/050009

§ 371 Date: Sep. 16, 2019

(30) Foreign Application Priority Data
Mar. 17, 2017 (PT) 109975

(51) Int. Cl. A47J 31/36; A47J 31/44; A47J 31/46; A23F 5/26

(52) U.S. Cl. CPC A47J 31/3676; A23F 5/26; A47J 31/461; A47J 31/4403

(57) ABSTRACT

The present invention discloses a beverage distribution disposition (1), in particular of aromatic beverages such as espresso coffee and similar, from brewing a respective edible substance, whereby said disposition (1) comprises a portion collection disposition (5), adapted for collecting an individual portion of edible substance, and a beverage discharge (4), and is advantageously configured so that can be handheld and manually actuated while transported.

The present invention further discloses a beverage distribution system, in particular a system provided with energy autonomy so that can be transported and operated simultaneously, presenting fluid supply means (11) provided in fluid connection upstream of said beverage distribution disposition (1).

The present invention further discloses a process of distribution of beverages by means of said beverage distribution system.

### FIELD OF THE INVENTION

The present invention refers to the field of systems for distribution of aromatic beverages by means of brewing of a respective edible substance, in particular to the field of systems for distribution of beverages adapted so that can operate in portable manner.

The present invention further refers to a process of operation of a beverage distribution system.

### BACKGROUND OF THE INVENTION

The prior art presents several solutions of portable beverage distribution systems, in particular of the backpack type, trolley, or similar.

The document EP 0866444 B1 discloses a cold or hot beverage distribution system configured with a general backpack-like shape. Said system comprises fluid pressurization means provided in the backpack-like part and connected by means of a pipe to respective beverage discharge means. In particular, said system presents pumping means that are manually operated, whereby a respective handle is arranged adjacent to the discharge edge of cups dispensing means. Said system further presents a manual discharge disposition provided distanced from said pumping actuation handle.

The documents EP 0583497 B1, WO 95/16634 and WO 96/19406 disclose systems of the same type whereby the discharge actuation means, in particular a manually operable valve, are provided in distal region of a beverage distribution pipe.

The documents WO 95/11853 and EP 1699732 B1 disclose other beverage distribution systems of the same type.

### GENERAL DESCRIPTION OF THE INVENTION

The objective of the present invention is to provide a beverage distribution disposition, in particular a disposition configured for being handheld, that provides means for preparing a beverage, including aromatic beverages such as espresso type coffee, tea and similar, by means of mixture of a pressurized flow with a single portion of edible substance supplied to said beverage distribution disposition, by means of a simple construction and, in particular, that provides an ergonomic operation with said single portions while being handheld.

This objective is attained according to the present invention by means of a beverage distribution disposition according to claim 1.

It is preferred when the beverage distribution disposition presents an envelope casing that at least partially confines a single portion collection disposition and is configured for being handheld, whereby the hand position enables opening said collection disposition and is away from a beverage discharge.

It is preferred when said envelope casing presents a characteristic dimension that is approximate to the dimension of a hand.

It is preferred when said envelope casing comprises a second casing region provided in a single piece with a first casing region and adapted so as to support a closing disposition, or provided as a separate piece from said first casing region and adapted so as to comprise at least one of said portion collection disposition and said beverage discharge.

It is preferred when said first and second casing regions jointly define a general angled shape, for example in a general pistol-like shape, or similar.

It is preferred when said first and second casing regions jointly define a substantially closed and hollow shape, adapted for housing a fluid connection inside, and preferentially presenting an entry opening adapted so as to provide introduction of a single portion into said portion collection disposition, and an exit opening adapted so as to provide the exit a single portion.

It is preferred when said first and second casing regions jointly define a substantially closed and hollow shape, adapted for housing said portion disposition collection inside thereof.

It is preferred when said envelope casing is adapted so as to support the movement of said closing disposition around a reference swivelling axis disposed in the front region and below the top region of said envelope casing, so that said closing element can be swivelled around said reference swivelling axis frontwards relative to said front region of said envelop casing.

It is preferred when said closing disposition further presents a retention mechanism that comprises a retention part provided in the edge region of said closing element, and an actuation part provided in a corresponding region of said envelope casing and preferentially configured in the form of an actuation button, whereby said retention mechanism is configured so that can block said closing element when the latter is in a closed position, by means of retention on said envelope casing.

It is preferred when said retention mechanism is provided so that can be actuated by a finger that is different from the finger actuating said actuation element, preferentially by a thumb finger, when said envelope casing is handheld.

A related objective of the present invention is to provide a beverage distribution system, in particular including a beverage distribution disposition, provided with energy autonomy so that can be transported and operated simultaneously, comprising a collection chamber adapted for collecting a single portion of edible substance, for example provided inside of a capsule, whereby said system presents a simple and ergonomic construction in terms of use and portability.

This objective is achieved according to the present invention by means of a system according to claim 13.

It is preferred when the beverage distribution system according to the present invention comprises a supply source of pressurized and heated fluid, and is provided so that can operate in mobile conditions, without connection to an external energy source.

It is preferred when said beverage distribution device further comprises at least one thermal and/or electrical energy storage device.

It is further preferred when said beverage distribution device comprises fluid pressurization means provided as a compressed gas recipient, and in fluid connection with said beverage distribution disposition.

Another objective of the present invention is to provide a process for preparing beverages that provides better ergonomic conditions of use and portability.

This objective is solved according to claim 16.

### DESCRIPTION OF THE FIGURES

The invention shall be explained in greater detail hereinafter based upon preferred embodiments thereof, and the attached figures.

The Figures show, in simplified schematic representations:

FIG. 1: system (1) for distributing beverages according to the present invention;

FIG. 2: perspective view of a first embodiment of a beverage distribution disposition (1) according to the present invention;

FIG. 3: side view of the embodiment of beverage distribution disposition (1) according to FIG. 2;

FIG. 4: exploded perspective view of the embodiment of beverage distribution disposition (1) according to FIG. 2;

FIG. 5: side-cut view of the embodiment of beverage distribution disposition (1) according to FIG. 2, in a closed position;

FIG. 6: side-cut view of the embodiment of beverage distribution disposition (1) according to FIG. 2, in an open position;

FIG. 7: exploded perspective view of a second embodiment of beverage distribution disposition (1) according to the present invention;

FIG. 8: front view and side-cut view, along the cut-plane AA, of the embodiment according to FIG. 7, in a closed position;

FIG. 9: front view and side-cut view, along the cut-plane BB, of the embodiment according to FIG. 7, in an open position.

### DETAILED DESCRIPTION OF PREFERRED EMBODIMENTS OF THE INVENTION

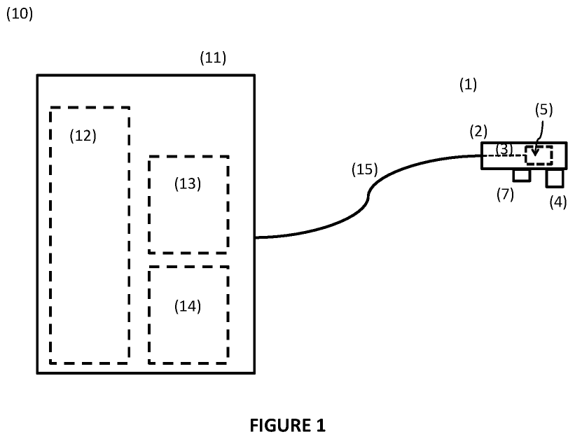

FIG. 1 schematically represents a system (10) for distributing beverages according to the present invention.

As represented, said system (10) comprises a disposition (1) for distribution of beverages that is provided in fluid connection with a fluid supply source (11) disposed upstream and adapted so as to provide a pressurized fluid flow and provided remotely from said beverage distribution disposition (1).

Said fluid supply source (11) comprises fluid storage means (12) adapted so that provide storage of a given quantity of fluid, fluid pressurization means (13) adapted so that can supply a fluid flow at a pressure comprised between 1 and 20 bar, and, optionally, fluid heating means (14) adapted so that can supply a fluid flow at a temperature comprised between 60 and 120° C.

The system (10) further includes fluid connection means (15) adapted so as to provide a fluid connection over a distance, and preferentially thermally insulated and with an extension smaller than 1.5 m, between said fluid supply source (11) and the beverage distribution disposition (1) provided apart from said fluid supply source (11).

Said beverage distribution disposition (1) presents an envelope casing (2), and a beverage discharge (4) adapted so that provides discharge of beverage.

According to a first inventive aspect, said beverage distribution disposition (1) further presents fluid supply means (3) adapted for connection with said fluid supply source (11) upstream, a portion collection disposition (5) adapted for collection of a single portion of edible substance, and disposed downstream of said fluid supply means (3) and upstream of said beverage discharge (4).

Moreover, said beverage distribution disposition (1) further presents an actuation disposition (7) including a start actuation element (71) adapted so that provides the start of beverage preparation cycle when actuated, whereby said start actuation element (71) is disposed so that can be actuated by the same hand that holds said envelope casing (2) and preferentially configured so that can be actuated by a finger, such as for example in the form of a trigger, or similar.

The beverage distribution disposition (1) according to the present invention thus advantageously provides the possibility of use of single portions of edible substance in the preparation of beverages with a disposition that can be operated in moving conditions, without connection to an external energy source, and the possibility of preparing each beverage being actuated by the same hand that holds the beverage discharge.

In this sense, it is further preferred when said envelope casing (2) presents said start actuation element (71) disposed on a side opposite to the side where there is the entry opening of access to said portion collection disposition (5), preferentially so that can be actuated by the pointing finger, when said beverage distribution disposition (1) is being handheld.

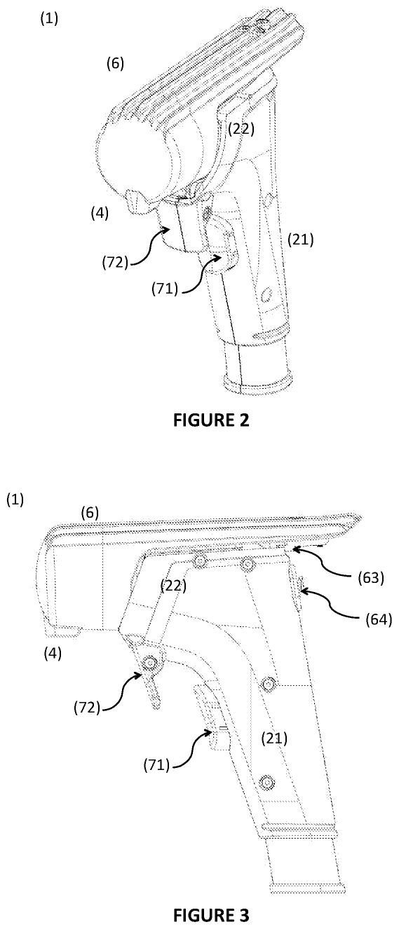

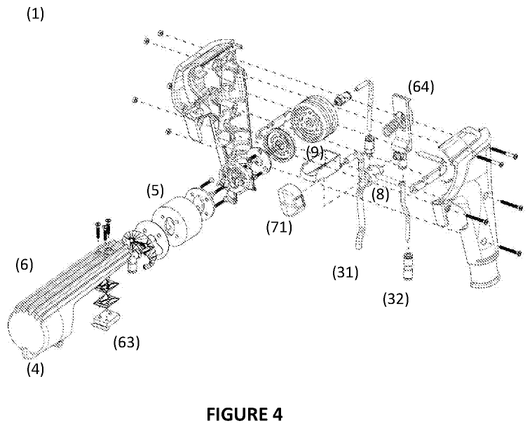

As represented in FIGS. 2, 3 and 4, the beverage distribution disposition (1) according to the present invention can present the general shape of a handgun, or similar.

As one can observe, the envelope casing (2) is configured so that can be handheld and presents a first and second casing regions (21, 22) provided in angled manner.

In particular, the first casing region (21) is configured in a handgrip shape and presents said start actuation element (71) in a trigger shape. The second casing region (22) partially confines a portion collection disposition (5) adapted for collection of a single portion of edible substance, and disposed downstream of said first fluid connection (3) and upstream of said beverage discharge (4).

There is further provided a closing disposition (6) including a lever-like element adapted so that can be moved relative to said envelope casing (2), as shall be explained in greater detail further below, between an open position where there is provided access to said portion collection disposition (5), and a closed position where said portion collection disposition (5) is confined in liquid tight manner.

It is further preferred when there is provided a protection element (72) disposed so as to prevent that the opening rotation of the closing disposition (6) may hit the finger on said start actuation element (71).

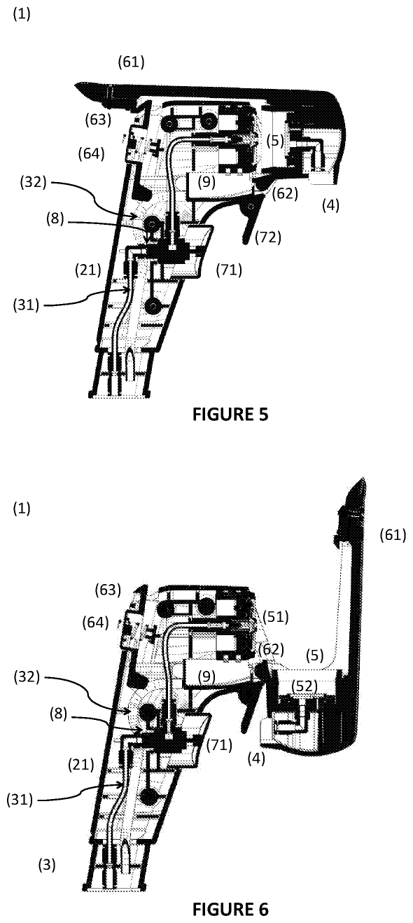

As one can better observe in FIGS. 5 and 6, said closing disposition (6) comprises a closing element (61) that develops along at least most part, preferentially all of the top region of said envelope casing (2), and that is provided as a lever supported so that can swivel around said reference swivel axis (62), between an open position, where provides access to the portion collection disposition (5), and a closed position, where closes said portion collection disposition (5).

It is particularly preferred when said closing element (61) is provided directly connected to said envelope casing (2) by means of a respective edge so that can carry out a swivelling movement around a reference swivel axis (62) arranged in the front region of said envelope casing (2), whereby the free edge of said closing element (61) is provided oriented to the posterior region of envelope casing (2), so that said closing element (61) can be swivelled around said reference swivel axis (62) from a top region of said envelope casing (2), where is located at a closed position, frontwards relative to the front region of said envelope casing (2), until reaching an open position.

It is further preferred when said envelope casing (2) is adapted so that can support the movement of said closing disposition (6) around a reference swivel axis (62) arranged in the front region and below the top region of said envelope casing (2), so that said closing element (6) can be swivelled around said reference swivel axis (62) frontwards relative to the front region of said envelope casing (2).

Moreover, as one can observe, said portion collection disposition (5) is adapted so that can be crossed by pressurized fluid along a direction at least approximately transversal or parallel to the beverage discharge direction, whereby said portion collection disposition (5) is confined upstream by a top wall that presents fluid injection means (51) provided in fluid connection with said first fluid connection (3), and is confined downstream by a base wall that presents beverage discharge means (52) provided in fluid connection with said beverage discharge (4).

According to a preferred embodiment of the beverage distribution disposition (1), there is further provided a distribution valve (8) inside of said envelope casing (2), disposed between said first fluid connection (31) upstream and the fluid injection means (51) for the portion collection disposition (5), whereby said distribution valve (8) is actionable by means of pressure upon said start actuation element (71), for example with the pointing finger of the hand holding the envelope casing (2), so that the fluid passage is released when the start actuation element (71) is pressured.

Moreover, it is further preferred when there is also provided a residues collection disposition (9) provided inside of said envelope casing (2) and adapted so that can collect liquid residues from inside of said portion collection disposition (5), whereby said resides collection disposition (9) is provided in fluid connection downstream with a second fluid connection line (32) configured so that discharges out of said envelope casing (2) of beverage distribution disposition (1), preferentially into a collection recipient provided on said fluid supply source (11).

According to another preferred embodiment, said beverage distribution disposition (1) further presents a retention disposition (63, 64) adapted so that can retain and release said closing disposition (6), whereby said retention disposition (63, 64) preferentially comprises a first retention part (63) and a second actuation part (64) that engages in removable manner on said first retention part (63) and can be disengaged when pressured.

In particular, it is preferred when the retention disposition (63, 64) is provided so that can be actuated with a finger different from the finger that actuated said start actuation element (71), preferentially by the thumb, when said disposition (1) is being handheld.

As shall be readily understood by the expert in the field, the beverage distribution system (10) according to the present invention provides several advantages in its use.

According to a first inventive aspect, the actuation of the closing disposition (6) and the actuation of the actuation disposition (7) is carried out by a user with the same hand that holds said disposition (1).

It is preferred when the step of providing a beverage preparation system (10) includes holding said beverage distribution disposition (1) with a given hand, and said step of introducing a single portion on said portion collection disposition (5) is carried out with the other hand.

It is preferred when the step of start of supply of pressurized fluid flow to said portion collection disposition (3), includes the actuation of an actuation device (7) provided as a button disposed on a region of a first support structure (6) below of said beverage discharge disposition (4).

It is preferred when the step of actuation of a closing disposition (6), so that said portion collection disposition (5) evolves from a closed position to an open position, including the release of a respective retention on the envelope casing (2), can be carried out with the same hand that holds the beverage distribution disposition (1), and when said actuation of closure of said portion collection disposition (5) can be carried out by the other hand.

It is also preferred when the step of providing a beverage distribution system (10) includes handholding an envelope casing (2) of said beverage distribution disposition (1), and not handholding a fluid supply source (11) provided in fluid connection upstream of said beverage distribution disposition (1).

It is further preferred when the step of actuation of start of supply of a pressurized fluid flow to said portion collection disposition (3), does not include the supply of energy from an energy source that is external to said beverage distribution system (10).

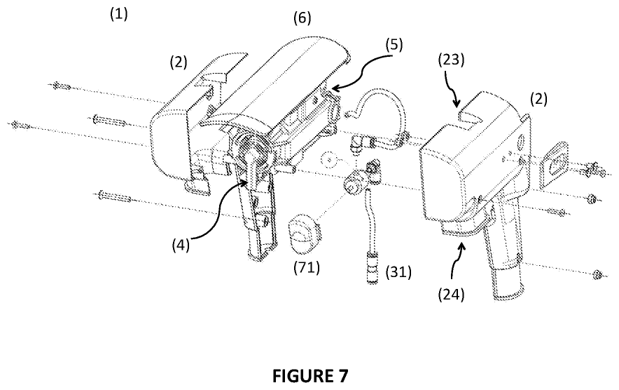

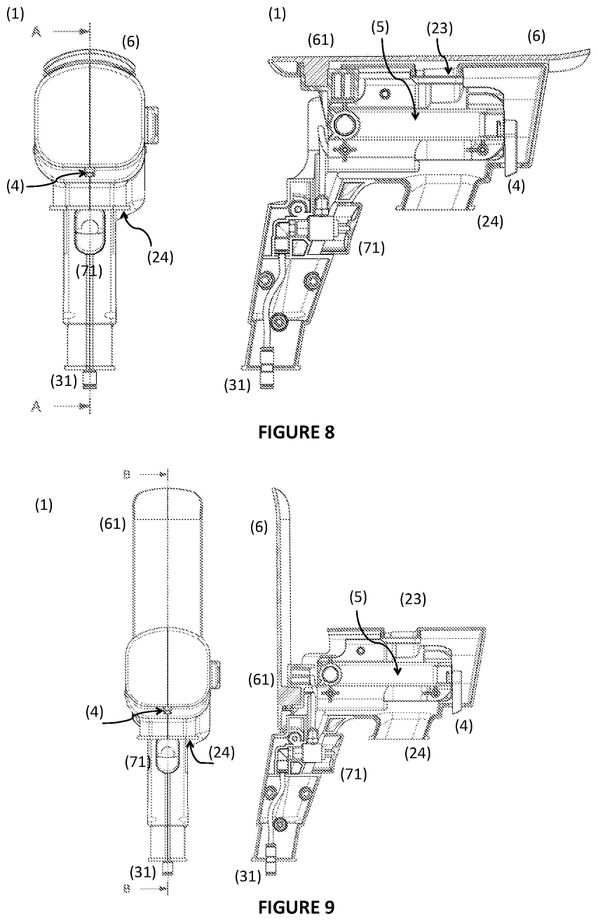

FIGS. 7 to 9 represent views of a second embodiment of beverage distribution disposition (1) according to the present invention.

In this case, the envelope casing (2) is still provided with a general form of the type with a general pistol wrist-like shape, and a hollow configuration adapted so that collects a portion collection disposition (5) inside thereof. Said portion collection disposition (5) presents in this case two parts, as generally from the expert in the technical field, and for example disclosed in documents WO 2017/176139 A1 and WO 2017/176140 A1 filed by the author of the present application, so that one herewith abdicates of a more detailed description thereof.

Said portion collection disposition (5) is provided in actuation connection with the closing disposition (6) that in this case comprises only a closing element (61) configured in the form of lever extending over the entire surface of the top region of said envelope casing (2) and adapted so that provides closing of said portion collection disposition (5) by means of said closing element (61) provided so that can be moved in a swivelling movement relative to said envelope casing (2), between an open position where provides access to said portion collection disposition (5), and a closed position where closes said portion collection disposition (5) in a liquid-tight manner.

According to a preferred embodiment, said envelope casing (2) presents an entry opening (23) on the upwards-oriented side, adapted so that provides the entry of each single portion into said portion collection disposition (5), and further an exist opening (24) on the downwards-oriented side, aligned with said portion collection disposition (5) so that provides exit of each single portion out of the beverage distribution disposition (1).

1. Beverage distribution disposition (1) adapted for preparing beverages by means of a pressurized fluid flow through an individual portion of an edible portion, said beverage distribution disposition (1) comprising:
an envelope casing (2) presenting a portion configured in a handgrip shape so that can be hand-held;
a fluid connection (31) adapted for connection of a pressurized fluid line that provides fluid connection with an upstream source of supply of pressurized fluid;
a beverage discharge (4),
characterized
in that said disposition (1) further presents:
a portion collection disposition (5) adapted for collecting an individual portion of said edible substance, for example provided inside of a capsule, and disposed downstream of said first fluid connection (31) and upstream of said beverage discharge (4),
a closing disposition (6) adapted so that provides actuation of said portion collection disposition (5) by means of a closing element (61) provided so that can be moved in swivelling movement relative to said envelope casing (2), between an open position where said portion collection disposition (5) is open, and a closed position where said portion collection disposition (5) is closed in a liquid-tight manner, and
an actuation disposition (7) including a start actuation element (71) adapted so that can provide start of the beverage preparation cycle, whereby said start actuation element (71) is arranged so that can be actuated by the same hand that holds said envelope casing (2) and is preferentially configured in trigger-like, button-like, or similar shape, so that can be actuated by a single finger.

2. Disposition (1) according to claim 1, characterized in that said start actuation element (71) is provided, preferentially on said envelope casing (2), on a side opposite to the side where there is said closing element (61) in a respective closed position, preferentially so that said start actuation element (71) can be finger actuated, for example by a pointing finger, when said envelope casing (2) is hand held.

3. Disposition (1) according to claim 1, characterized in that said envelope casing (2) is configured for being handheld, and in that said portion collection disposition (5) presents a shape and dimensions adapted for collecting an individual portion of edible substance, preferentially provided inside of a capsule.

4. Disposition (1) according to claim 1, characterized in that said envelope casing (2) presents a first casing region (21) adapted so that can be manually held, whereby said first casing region (21) comprises said fluid connection (31), and a second casing region (22) adapted so that supports said portion collection disposition (5).

5. Disposition (1) according to claim 1, characterized in that said closing disposition (6) comprises a closing element (61) provided directly united by means of a respective edge to said envelope casing (2), without intercalary movement transmission elements, so that can carry out a swivelling movement around a swivel reference axis (62) disposed in the front region of said envelope casing (2), whereby the freed edge of said closing element (61) is provided oriented to the posterior region of envelope casing (2), so that said closing element (61) can be swivelled around said reference swivel axis (62) from a top region of said envelope casing (2), frontwards relative to the front region of said envelope casing (2), until reaching an open position.

6. Disposition (1) according to claim 1, characterized in that said closing element (61) is provided as a lever supported so that can swivel around said reference swivelling axis (62) between an open position and a closed position, thereby driving said portion collection disposition (5) into a respective open and closed positions.

7. Disposition (1) according to claim 1, characterized in that said closing element (61) is developing along at least most part, preferentially all of the top region of said envelope casing (2), more preferentially further beyond the distal edge of said top or posterior region.

8. Disposition (1) according to claim 1, characterized in that at least said beverage discharge (4), preferentially also said portion collection disposition (5), are configured so that can be jointly moved, without intercalary movement transmission elements, as a result of actuation of said closing element (61), preferentially are provided in a single piece with said closing element (61).

9. Disposition (1) according to claim 1, characterized in that said second casing part (22) comprises the portion collection disposition (5), and in that the beverage discharge (4) and the closing disposition (6) are configured so that can be jointly moved as a result of actuation of said closing element (61), preferentially are provided in a single piece with said closing element (61).

10. Disposition (1) according to claim 1, characterized in that said portion collection disposition (5) is adapted so that can be crossed by a pressurized flow along a direction at least approximately transversal or parallel to the beverage flow direction, whereby said portion collection disposition (5) is confined upstream by a top wall that presents fluid injection means (51) provided in fluid connection with said first fluid connection (3), and is confined downstream by a base wall that presents beverage discharge means (52) provided in fluid connection with said beverage discharge (4).

11. Disposition (1) according to claim 1, characterized in that inside of said envelope casing (2) there is provided at least one of:
a distribution valve (8) disposed between said first fluid connection (31) upstream and fluid injection means (51) downstream, whereby said distribution valve can be actuated by means of pressure applied upon said start actuation element (71), for example by means of the pointing finger of a hand holding the envelope casing (2), so that the fluid passage is released while the actuation element (71) remains pressured.
a residues collection disposition (9) adapted so that can collect liquid residues from the interior of said portion collection disposition (5), whereby said residues collection disposition (9) is provided in fluid connection downstream with a second fluid line (32) configured so that discharges outwards of said envelope casing (2).

12. Disposition (1) according to claim 1, characterized in that said envelope casing (2) presents an entry opening (23) on the upwards-oriented side thereof, adapted so that provides entry by each single portion into said portion collection disposition (5), and further an exit opening (24) on the downwards-oriented side thereof, aligned with said portion collection disposition (5) so that provides exit of each single portion out of said beverage distribution disposition (1).

13. System (10) for distributing beverages such as for example espresso-type coffee and similar aromatic beverages, by means of brewing an edible substance, said system (10) including:
a source (11) of fluid supply adapted so as to provide a pressurized fluid flow,
a beverage distribution disposition (1), in particular a beverage distribution disposition (1) according to claim 1,
whereby said fluid supply source (11) is provided remote and in fluid communication with said beverage discharge disposition (1),
characterized
in that said beverage distribution disposition (1) comprises a portion collection disposition (5) of edible substance, and
in that said fluid supply source (11) is associated with a transportable support, for example of backpack or trolley type, and provided with energy autonomy so that said system (10) can distribute a plurality of beverages along a given distance autonomously from external energy sources.

14. System (10) according to claim 13, characterized in that said fluid supply source (11) comprises:
fluid storage means (12) adapted so that provide storage of a given fluid amount, preferentially fluid storage means thermally insulated so as to maintain said fluid at a temperature comprised between 60 and 100° C. during a previously defined operation period;
optionally, fluid storage means (14) adapted so that can supply a fluid flow (FS) at a temperature comprised between 60 and 100° C.;
fluid pressurization means (13) adapted so that can supply a fluid flow at a pressure comprised between 1 and 20 bar, preferentially above 8 bar,
fluid connection means (15) adapted so as to provide fluid connection between said fluid supply source (11), and a first fluid line (31) provided inside of said envelope casing (2) and in fluid connection with the portion collection disposition (5) downstream thereof.

15. System (10) according to claim 13, characterized in that said fluid supply source (11) further presents transport means (16), adapted so as to provide transport thereof at the back of an individual, for example in a backpack manner, or to provide displacement thereof by an individual, for example in a vehicle manner.

16. Process for distribution of a beverage characterized in that includes the following steps:
Providing a system (10) for preparing beverages comprising a beverage distribution disposition (1) presenting an envelope casing (2) configured so that can be handheld, in particular a disposition (1) according to claim 1,
actuating a closing disposition (6) so that said portion collection disposition (5) evolves from a closed position to an open position, preferentially including the release of a respective retention on the envelope casing (2);
introduce a single portion in the portion collection disposition (5);
actuating said closing disposition (6) so that said portion collection disposition (5) evolves from the open position to the closed position;
actuating an actuation device (7) so that the injection of pressurized fluid into said portion collection disposition (5) is started;
beverage discharge through said beverage discharge (4);
whereby said actuation of closing disposition (6) and said actuation of actuation device (7) is carried out by a user with the same hand that holds said disposition (1).

17. Process according to claim 16, characterized in that said step of introducing a single portion into said portion collection disposition (5) is carried out with one hand while holding said beverage distribution disposition (1) with the other hand of the same user.

18. Process according to claim 16, characterized in that said step of starting the supply of a pressurized fluid flow to said portion collection disposition (5), includes the actuation of an actuation device (7) provided with a button-like, or a trigger-like configuration and disposed on a region, preferentially of said envelope casing (2), in the proximity of said beverage discharge (4).

19. Process according to claim 16, characterized in that said step of actuation of closing disposition (6), so that said portion collection disposition (5) evolves from a closed position to an open position, including the release of respective retention on the envelope casing (2), can be carried out with the same hand that holds the beverage distribution disposition (1), and in that said actuation of closing of said portion collection disposition (5) can be carried out by the other hand.

20. Process according to claim 16, characterized in that said step of providing a system (10) of beverage distribution includes handholding an envelope casing (2) of said beverage distribution disposition (1), and not handholding a source of fluid supply (11) provided upstream and in fluid connection with said beverage distribution disposition (1).

21. Process according to claim 16, characterized in that said step of actuation of start of supply of a pressurized fluid flow to said portion collection disposition (5), does not include energy supply from an energy source external to said system (10) of beverage distribution.
